(19) United States
(12) Patent Application Publication
(10) Pub. No.: US 2009/0055551 A1
(43) Pub. Date: Feb. 26, 2009

(54) RE-ROUTING METHOD AND SYSTEM

(75) Inventors: Stephen Ross Baxter, Queensland (AU); Bevan Andrew Slattery, Queensland (AU)

Correspondence Address: MEYERTONS, HOOD, KIVLIN, KOWERT & GOETZEL, P.C., P.O. BOX 398, AUSTIN, TX, 78767-0398, US

(73) Assignee: IP ENTERPRISES PTY LIMITED, Queensland (AU)

(21) Appl. No.: 11/596,152

(22) PCT Filed: May 11, 2005
(86) PCT No.: PCT/AU2005/000678

§ 371 Date: Sep. 9, 2008

(30) Foreign Application Priority Data
May 11, 2004 (AU) 2004902468

(51) Int. Cl. G06F 15/173

(52) U.S. Cl. 709/239

(57) ABSTRACT

A method of re-routing a connection request by an end user of a network, comprising: selecting one or more proscribed destination sites in respect of which requests are to be re-routed; communicating information relating to the identity of the at least one proscribed destination site to a network service provider to which end users make requests for connection to various sites; arranging with the network service provider so that upon receipt by the network service provider, of a request by an end user for connection to a proscribed destination site, a connection is established between the network service provider and a desired destination site; and wherein the end user's request for connection to the proscribed destination site is routed to the desired destination site.

### FIELD OF THE INVENTION

The present invention relates to a method and a system of re-routing requests made to a service provider providing access to a network, and especially, but not exclusively, requests made to a service provider providing access to the internet.

### BACKGROUND

The inventors have determined that it may be desirable to re-route an end user's request for connection to a website so that the end user is connected to a website other than the website to which connection is requested.

### SUMMARY OF THE INVENTION

According to a first aspect of the present invention there is provided a method of re-routing a connection request by an end user of a network, comprising:

selecting one or more proscribed destination sites in respect of which requests are to be re-routed;

communicating information relating to the identity of the at least one proscribed destination site to a network service provider to which end users make requests for connection to various sites;

arranging with the network service provider so that upon receipt by the network service provider, of a request by an end user for connection to a proscribed destination site, a connection is established between the network service provider and a desired destination site; and

wherein the end user's request for connection to the proscribed destination site is routed to the desired destination site.

Preferably, the method is a method of re-routing a request by an end user of the internet for connection to a website.

Preferably the method includes alteration of one or more routing protocols used by the service provider.

Preferably the method includes alteration of routing preferences used by the service provider in respect of the routing of requests for connection to at least one proscribed site.

Preferably, the method is a method of re-routing a request by an end user which has been made by the end user activating a link, preferably a hypertext link.

The method may comprise re-routing a request by an end user which has been made by the end user activating a link contained in an email.

The method may comprise re-routing a request made by an end user for connection to a website, in the circumstances that the requested website is not the website to which the end user believes connection is being requested.

The method may comprise re-routing a request made by an end user for connection to a website, where the request is made by the end user activating a link to a proscribed site, said link being disguised as a link to a different, non-proscribed, site.

The method may comprise receiving payment from an entity related to the non-proscribed website.

The entity may be a financial institution.

The entity may provide information regarding the identity of one or more proscribed sites.

The entity may provide information which is provided to the end user via the desired destination site.

Preferably information is provided by the entity to a re-routing administrator.

Preferably a re-routing administrator communicates details of the one or more proscribed sites to the network service provider.

Preferably a re-routing administrator provides information to at least one network service provider relating to why a proscribed site has been determined to be proscribed.

Preferably the network service provider is given the option of accepting or declining re-routing instructions in relation to a given proscribed site, based on the information relating to why that given proscribed site has been determined to be proscribed.

Preferably a re-routing administrator provides the desired destination site.

The re-routing administrator may include information provided by the entity on the desired destination site.

There may be a plurality of entities each with a similar relationship to the system administrator.

The proscribed site may be a site which imitates a non-proscribed site.

The proscribed site may be a site which imitates a site to which users of the site disclose confidential information.

The proscribed site may be a site which imitates a site of an entity such as a financial institution.

Preferably the desired destination site provides an explanation to the end user relating to the user's request for connection to the proscribed site.

Preferably, the connection between the network service provider and the desired destination site is an Internet connection.

Preferably, the connection between the network service provider and the desired destination site allows two-way communication.

Preferably, the end user's request for connection to the proscribed destination site includes an address for the proscribed site.

Preferably, the connection between the network service provider and the desired destination site allows routing to the desired destination site without advertising the address of the proscribed site to intermediate routers.

Preferably, the connection between the network service provider and the desired destination site allows routing to the desired destination site without making the address of the proscribed site available to intermediate routers.

Preferably, the connection between the network service provider and the desired destination site is a tunnel.

Preferably, the tunnel is created using an IP tunnelling protocol.

Connection to the desired destination site may comprise connection to a re-routing administrator system which provides one or more destination sites.

The method preferably comprises selecting more than one proscribed destination site.

The desired destination site may provide information related to the specific proscribed site to which the rerouted request was originally addressed.

The method preferably comprises communicating details of one or more proscribed destination sites to more than one service provider.

The or each service provider is preferably an internet service provider (ISP). Details of one or more proscribed destination sites may additionally or alternatively be communicated to one or more service providers other than ISPs.

According to a second aspect of the present invention, there is provided a method of re-routing a connection request by an end user of a network comprising:

receipt, by a network service provider to which end users make requests for connection to sites, of information relating to the identity of one or more proscribed destination sites in respect of which requests are to be re-routed;

receipt by the network service provider, of a request by an end user for connection to a proscribed destination site;

establishing a connection between the network service provider and a desired destination site; and

routing the end user's request for connection to the proscribed destination site to the desired destination site.

It will be appreciated that features recited above which are preferable and/or optional in relation to a method in accordance with the first aspect of the invention may also be preferable and/or optional in relation to a method in accordance with the second aspect.

According to a third aspect of the present invention there is provided a re-routing system for re-routing requests by end users of a network for connection to one or more proscribed sites, comprising:

means for receiving requests from end users for connection to sites:

an information system for providing information relating to the identity of one or more proscribed sites; and

means for providing access to at least one desired destination site to which requests for connection to a proscribed site are re-routed;

wherein the means for receiving requests from end users is able to re-route requests by end users for connection to a proscribed site to a desired destination site by forming a connection with the desired destination site and routing data packets which are addressed to the proscribed site to the desired destination site via one or more network routing systems which are distinct from said means for receiving requests from end users and from the desired destination site, such that the routing protocols of the one or more network routing systems cannot utilise the address of the proscribed site in the data packets to route the data packets to the proscribed site.

Preferably, the means for receiving requests from end users for connection to sites comprises a network service provider.

Preferably, the information system is for providing information relating to the identity of one or more proscribed sites to the network service provider.

The system may include the desired destination site.

Preferably the formed connection is a virtual connection.

Preferably the formed connection comprises a tunnel.

Preferably data packets which are initially addressed to the proscribed site are routed to the desired site via one or more autonomous routing systems which are distinct from the network service provider and the desired destination site.

The re-routing system may operate using a method in accordance with the first aspect of the present invention and/or may include features which are described as being optional in relation to the first aspect.

According to a fourth aspect of the present invention, there is provided a method of preventing an end user of a network from being exposed to an undesired site, comprising:

identifying one or more undesired sites;

providing one or more desired sites;

arranging for the rerouting of an end user's request for connection to an undesired site so that the request is routed to a desired site.

Preferably the method is a method of protecting an end user of a network from exposure to an undesired site which is part of a fraud.

Preferably the method is a method of preventing the end user from being exposed to an undesired website.

Preferably the arranging for the re-routing of the end user's request comprises arranging for a network service provider to re-route a request from an end user.

Preferably the method includes arranging for the network service provider to route the end user's request for connection to an undesired site, via at least one intermediate routing system, to the desired site.

Preferably the method includes arranging for a tunnel to be provided between the network service provider and a provider of the desired site.

Further preferred features of the various aspects will be evident from the other aspects, and/or from the optional features thereof.

### BRIEF DESCRIPTION OF THE DRAWINGS

Preferred embodiments of aspects of the invention will now be described, by way of example only, with reference to the accompanying drawings in which:

FIG. 1 is a block diagram illustrating a method of re-routing in accordance with embodiments of the present invention;

FIG. 2 is a schematic illustration of the routing between an ISP and a re-routing administrator in an embodiment of the invention including a tunnel; and

FIG. 3 is a schematic illustration of the routing between an ISP and a re-routing administrator in an embodiment of the invention, illustrating why a tunnel is used in some embodiments.

### DETAILED DESCRIPTION OF PREFERRED EMBODIMENTS

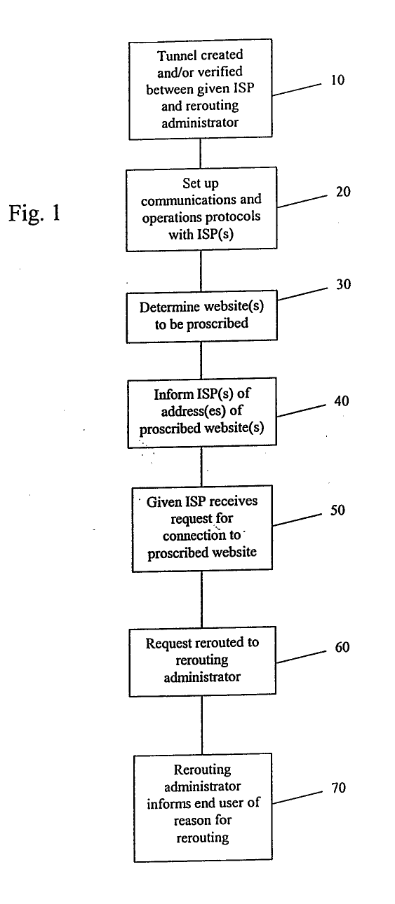

With reference to FIGS. 1 to 3, a preferred embodiment of a re-routing method is a method for re-routing requests made by end users, e.g. end user 110, of the internet 115.

One example of where such re-routing is desirable is where a user has requested connection to a fraudulent website by clicking on a link received in a spam email as part of a scam. In one known scam, a scam operator attempts to gain confidential financial information, such as bank account details and passwords, by sending (perhaps millions of) spam emails purporting to be from a bank, and including a link to a website which is an imitation of the bank's website. Each recipient of the email is informed that a security breach has occurred and is invited to follow the link in order to remedy the breach. Once connected to the fraudulent website the recipient is asked to enter his account details and password and may do so, believing that he is connected to the bank's bona fide website, and that entering these details is necessary to remedy the claimed breach of security. In a preferred embodiment it has been recognised that it is desirable to re-route potential victims' requests to access such fraudulent websites.

The preferred embodiment involves cooperation of ISP's, e.g. ISP 120, to effectively reroute end users' requests for connection to proscribed websites, e.g. proscribed website 140, to a desired destination, which may be a website or system of a re-routing administrator 130 of the re-routing method.

For convenience, at least some of the following description describes a preferred embodiment by reference to a single end user 110, a single proscribed website 140 and a single involved ISP 120, but the skilled person will understand that the embodiment being described will typically involve more than one of each. In practice, a large number of ISPs will preferably be included, and a request for connection to any one of a number of proscribed sites, by any end user (of any one of those ISPs) will result in re-routing of the request.

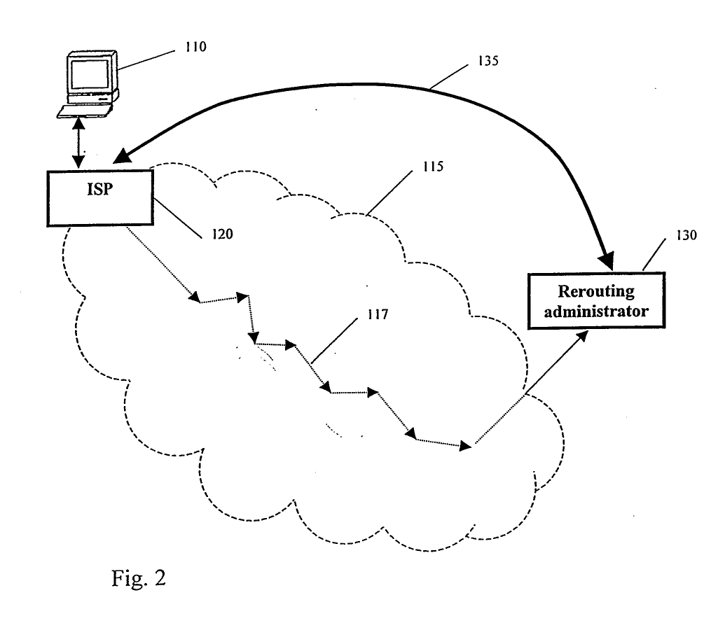

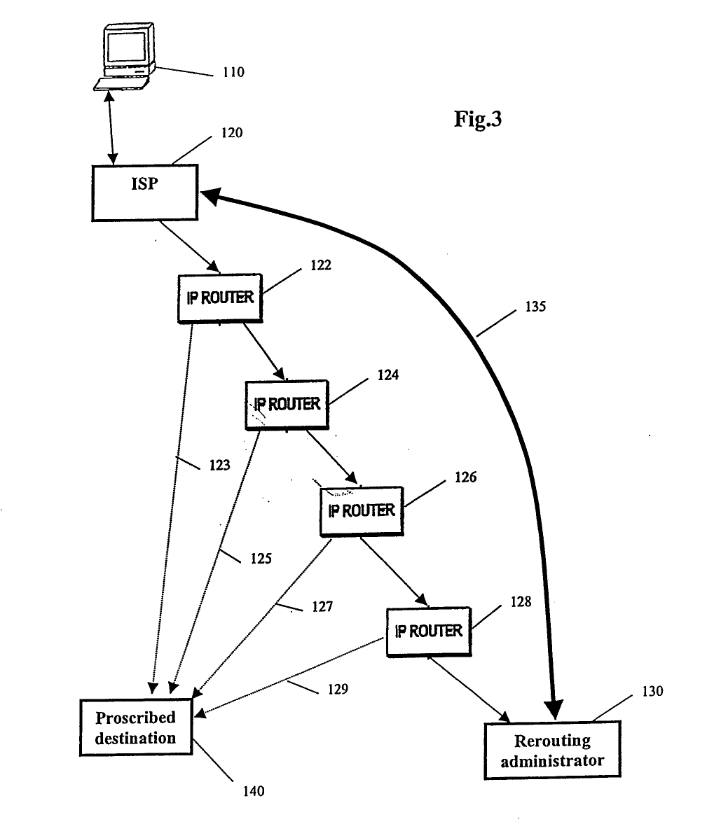

A first step, designated by reference numeral 10 in FIG. 1, is for an administrator of the re-routing method to establish a tunnel 135 (shown schematically in FIGS. 2 and 3) between the ISP and the administrator, using a suitable tunnelling protocol. A number of tunnelling protocols are known per se, and selection of a suitable protocol may be made according to preference of the ISP and re-routing administrator. By way of example, IP in IP tunnelling protocol or a GRE (generic route encapsulation) tunnelling protocol may be suitable. The use of tunnels in internet communications is known per se, and will not be described in detail herein. Essentially use of the tunnel 135 establishes communications which behave as if the ISP were in direct interconnection with the administrator, even though the actual data packets might pass through many physically intermediate IP routers. FIG. 2 illustrates that an indirect physical route, designated by the broken arrows 117, may be provided through the internet 115, but illustrates that the tunnel 135 allows communication between the ISP 120 and the re-routing administrator 130 as if no intermediate systems were present.

The next step, designated 20 in FIG. 1, is for the re-routing administrator 130 to set up suitable communication systems and protocols with the ISPs.

On a technical level this may involve adding to or altering some parts of the ISPs' routing configurations to allow them to set up a virtual connection between their routers and the re-routing administrator. The configurations are provided so that the ISPs heavily prefer routes generated by the re-routing system administrator (over routes advertised by normal IP routers). Most ISPs currently use Border Gateway Protocol 4 (BGP4) and setting up the desired routing in ISPs will typically require addition or amendment of only a small amount of code in such a routing configuration. The re-routing system administrator may set up or amend the routing protocol changes using the tunnel 135.

On a practical and commercial level, this step may involve satisfying an ISP that the re-routing administrator is bona fide so that the ISP will be willing to act on the administrator's re-routing instructions.

The administrator determines which websites are to be proscribed, block 30 in FIG. 1. This determination may be made by the administrator 130, for example by gathering information on scam websites. Alternatively or additionally the administrator may receive details of websites to be proscribed from third parties, for example from large financial institutions which wish to protect their customers and themselves from the effects of the scams described above. In a preferred embodiment the institution will provide the destination IP address or hostname of the site to be proscribed, the protocol the fraudulent incident is being perpetrated via, the port number the fraudulent incident is being conducted over, an explanation of why the site is to be proscribed and the information to be displayed to end users when they are re-routed to a desired destination site. These details may be provided by a web interface with the re-routing system administrator.

The administrator communicates details of the proscribed websites to the ISPs, block 40 in FIG. 1, using predetermined procedures established at the set-up stage (blocks 10, 20 in FIG. 1). Typically these details will be electronically communicated to the ISPs so that they can be easily incorporated into the ISPs' operations. The ISPs may be informed of the details of the proscribed sites using BGP4 routing sessions with the system administrator. These routing sessions may also provide routing information which is to be used by the ISPs when re-routing requests for connection to proscribed sites. In a preferred embodiment these routing sessions are conducted over tunnels 135. Of course determination of sites to be proscribed, and communication of those sites to ISPs continues on an ongoing basis.

When an ISP 120 receives a request from an end user 110 for connection to a proscribed site 140, see block 50 in FIG. 1, rather than routing the request in the normal way, the ISP establishes a virtual connection with the administrator. In the preferred embodiment this comprises using the tunnel 135. As illustrated in FIGS. 2 and 3 the tunnel allows two-way communication.

FIG. 3 illustrates why tunnels 135 are used in the preferred embodiment. FIG. 3 shows an example in which first to fourth IP routers 122, 124, 126, 128, respectively are used to route data packets between the ISP 120 and the re-routing administrator 130. The ISP 120 has been informed by the administrator 130 of the address of a proscribed destination site 140, and has received a request from an end user 110 for connection to the proscribed destination site 140. Consequently the ISP attempts to re-route the end user's request to the administrator 130. However, in the absence of a tunnel 135, the destination address requested by the end user is typically read by each of the intermediate IP routers 122, 124, 126, 128, and this leaves scope for any one of the routers 122, 124, 126, 128, to route the data packets to the proscribed destination site 140. This undesirable routing by any of the respective first to fourth IP routers 122, 124, 126, 128, is indicated by the first to fourth respective broken arrows 123, 125, 127, 129 in FIG. 3. This potential for undesired routing by intermediate IP routers is a consequence of the fact that the ISP 120 does not actually change the destination address of the request when it transmits the end user's request. Whilst it would be possible to arrange for the ISP to change the address in the data packets from the proscribed address to the desired destination addressed (and therefore avoid undesired re-routing by intermediate IP routers) this would involve substantial change to the operations of the ISP. Providing the tunnel 135 between the ISP 120 and the re-routing administrator 130 provides a straightforward and easily implemented way of preventing intermediate IP routers from routing the data packets to the proscribed destination site 140.

It will be appreciated that other ways of preventing intermediate IP routers from routing the data packets to the proscribed destination site 140 may be possible: for example, ensuring that all intermediate IP routers are cooperative with the re-routing administrator 130, and implement the re-routing administrator's re-routing instructions. However, such an alternative would be very difficult to implement and use of tunnels is preferred.

Referring again to FIG. 1, using the tunnel 135, the end user's request is effectively re-routed to the re-routing administrator 130, see block 60. The end user's request for connection to the proscribed site is thus re-routed, by the ISP, to the administrator. However, the end user will not, at this stage, be aware that the request he has made was to a proscribed site or that his request for connection has been re-routed.

The re-routing administrator 130 then informs the end user that re-routing has occurred, and the reason for the re-routing. This may be achieved in a number of ways, for example by displaying explanatory material and/or by providing a link to the genuine website that the end user was intending to connect to. Typically the end user will be provided with an explanation of the scam, and reinforcement of the message that emails will never be used by the financial institution concerned as a means of confidential communication. It is envisaged that financial institutions will be willing to pay in return for the re-routing administrator providing the described service since this would provide protection to the institutions and their customers. The financial institutions may therefore be considered to be the primary “users” of the service being provided.

The re-routing of end users' attempts to access dangerous or fraudulent websites has benefits over merely blocking access to known fraudulent websites, since it allows end users to be educated about the frauds being perpetrated, or to be given other information regarding the reason for re-routing. This is likely to lead to a reduction of inappropriate behaviour by end users. This, in turn, may reduce inappropriate behaviour and/or the success of subsequent frauds.

In practice it would be desirable to have as many ISPs as possible acting in cooperation with a single re-routing administrator. This would allow protection of all end users of those ISPs. If the ISPs act as intermediate IP routers they may also protect subscribers of other ISPs, by re-routing data packets received via those ISPs.

This would also allow rapid reaction to the detection of frauds, since implementation of re-routing of requests to access the fraudulent website could be almost immediate. Co-operating ISPs would provide a better service to their subscribers by providing them with an enhanced degree of protection from fraud, and could be certified by the re-routing administrator. It is envisaged that certified ISPs would be preferred by potential customers. It will be appreciated that IP routers which are not ISPs, and other network service providers, may beneficially act in co-operation with the re-routing administrator.

It will be appreciated that variations of the described embodiment have applications other than protecting end users and financial institutions from internet-based financial fraud. For example, possible uses of the re-routing method and system include: filtering of categorised content; spam and virus protection; and circumvention of other undesirable internet incidents.

It will be appreciated that re-routing of end users' requests for connection to websites is a practice which could be subject to abuse, ranging from businesses wishing to reroute traffic from competitors' websites, to fraudsters wishing to reroute traffic from financial institutions' websites to fraudulent imitation sites. Thus appropriate security provisions are built into preferred embodiments, and re-routing administrators must be trustworthy and must exercise suitable quality control over the information they receive regarding websites which it is proposed to proscribe.

In a preferred embodiment the system administrator will only issue routing updates for an incident for an initial 48 hours, after which period the incident will be downgraded to a non-active incident. If the financial institution (or other user) provides more data, the re-routing can then be extended for 72 hours and this process can be repeated as many times as is necessary. Of course other time periods or arrangements may be used.

Furthermore, in some embodiments the or each ISP may be given the opportunity to veto the re-routing system administrator's selection of proscribed sites. In such an embodiment the re-routing system administrator would provide reasons for suggesting that a site be proscribed, and the ISP could decide whether or not to re-route requests for connection to that site, based on the reasons provided.

It will also be appreciated that although the re-routing administrator performs a number of functions in the preferred embodiment (e.g., setting up appropriate protocols in the ISPs, determining websites to be proscribed, informing ISPs of the proscribed websites, acting as the destination to which requests are rerouted and providing information regarding the re-routing) it is not necessary that the same entity perform all of these functions.

This patent application claims priority from Australian application 2004902468 the entire contents of which are incorporated herein by reference.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and improvements may be incorporated without departing from the scope of the present invention.

1. A method of re-routing a connection request by an end user of a network, comprising:
selecting one or more proscribed destination sites in respect of which requests are to be re-routed;
communicating information relating to the identity of the at least one proscribed destination site to a network service provider to which end users make requests for connection to various sites;
arranging with the network service provider so that upon receipt by the network service provider, of a request by an end user for connection to a proscribed destination site, a connection is established between the network service provider and a desired destination site; and
wherein the end user's request for connection to the proscribed destination site is routed to the desired destination site.

2. A method of re-routing a connection request by an end user of a network comprising:
receipt, by a network service provider to which end users make requests for connection to sites, of information relating to the identity of one or more proscribed destination sites in respect of which requests are to be re-routed;
receipt by the network service provider, of a request by an end user for connection to a proscribed destination site;
establishing a connection between the network service provider and a desired destination site; and
routing the end user's request for connection to the proscribed destination site to the desired destination site.

3. A method as claimed in claim 1, wherein the method is a method of re-routing a request by an end user of the internet for connection to a website.

4. A method as claimed in claim 1, wherein the method includes alteration of one or more routing protocols used by the service provider.

5. A method as claimed in claim 4, wherein the method includes alteration of routing preferences used by the service provider in respect of the routing of requests for connection to at least one proscribed site.

6. A method as claimed in claim 3, wherein the method is a method of re-routing a request by an end user made by the end user activating a link.

7. A method as claimed in claim 6, wherein the method is a method of re-routing a request by an end user made by the end user activating a hypertext link.

8. A method as claimed in claim 6, wherein the method comprises re-routing a request by an end user made by the end user activating a link contained in an email.

9. A method as claimed in claim 6, wherein the method comprises re-routing a request by an end user for connection to a website, in the circumstances that the requested website is not the website to which the end user believes connection is being requested.

10. A method as claimed in claim 6, wherein the method comprises re-routing a request made by an end user for connection to a website, where the request is made by the end user activating a link to a proscribed site, said link being disguised as a link to a different, non-proscribed, site.

11. A method as claimed in claim 10, wherein the method comprises receiving payment from an entity related to the non-proscribed website.

12. A method as claimed in claim 11, wherein the entity provides information regarding the identity of one or more proscribed sites.

13. A method as claimed in claim 11, wherein the entity provides information which is provided to the end user via the desired destination site.

14. A method as claimed in claim 1, wherein a re-routing administrator communicates details of the one or more proscribed sites to the network service provider.

15. A method as claimed in claim 14, wherein the re-routing administrator provides information to at least one network service provider relating to why a proscribed site has been determined to be proscribed.

16. A method as claimed in claim 15, wherein said at least one network service provider is given the option of accepting or declining re-routing instructions in relation to a given proscribed site, based on the information relating to why that given proscribed site has been determined to be proscribed.

17. A method as claimed in claim 1, wherein a re-routing administrator provides the desired destination site.

18. A method as claimed in claim 17, wherein at least one entity with an interest in re-routing users' requests to a proscribed site provides information regarding the identity of one or more proscribed sites to the re-routing administrator, and the re-routing administrator includes information provided by the entity on the desired destination site.

19. A method as claimed in claim 1, wherein the proscribed site is a site which imitates a non-proscribed site to which users of the non-proscribed site disclose confidential information.

20. A method as claimed in claim 19, wherein the proscribed site is a site which imitates a site of an entity such as a financial institution.

21. A method as claimed in claim 1, wherein the desired destination site provides an explanation to the end user relating to the user's request for connection to the proscribed site.

22. A method as claimed in claim 1, wherein the end user's request for connection to the proscribed site includes an address for the proscribed site.

23. A method as claimed in claim 22, wherein the connection between the network service provider and the desired destination site allows routing to the desired destination site without advertising the address of the proscribed site to intermediate routers.

24. A method as claimed in claim 23, wherein the connection between the network service provider and the desired destination site allows routing to the desired destination site without making the address of the proscribed site available to intermediate routers.

25. A method as claimed in claim 1, wherein the connection between the network service provider and the desired destination site is a tunnel.

26. A method as claimed in claim 25, wherein the tunnel is created using an IP tunnelling protocol.

27. A method as claimed in claim 1, wherein the method comprises selecting more than one proscribed destination site, and wherein connection to the desired destination site comprises connection to a re-routing administrator system which provides more than one desired destination site.

28. A method as claimed in claim 27, wherein a request for connection to a given proscribed site is rerouted to a desired destination site which provides information related to the specific proscribed site to which the rerouted connection request was originally made.

29. A method as claimed in claim 1, wherein the method comprises communication of details of one or more proscribed destination sites to more than one service provider.

30. A method as claimed in claim 1, wherein the or each service provider is an internet service provider (ISP).

31. A re-routing system for re-routing requests by end users of a network for connection to one or more proscribed sites, comprising:
means for receiving requests from end users for connection to sites;
an information system for providing information relating to the identity of one or more proscribed sites; and
means for providing access to at least one desired destination site to which requests for connection to a proscribed site are re-routed;
wherein the means for receiving requests from end users is able to re-route requests by end users for connection to a proscribed site to a desired destination site by forming a connection with the desired destination site and routing data packets which are addressed to the proscribed site to the desired destination site via one or more network routing systems which are distinct from said means for receiving requests from end users and from the desired destination site, such that the routing protocols of the one or more network routing systems cannot utilise the address of the proscribed site in the data packets to route the data packets to the proscribed site.

32. A system as claimed in claim 31 wherein the means for receiving requests from end users for connection to sites comprises a network service provider.

33. A system as claimed in claim 31 wherein the information system is for providing information relating to the identity of one or more proscribed sites to the network service provider.

34. A system as claimed in claim 31 wherein the system includes the desired destination sites.

35. A system as claimed in claim 31, wherein the formed connection is a virtual connection.

36. A system as claimed in claim 35, wherein the formed connection comprises a tunnel.

37. A system as claimed in claim 31, wherein data packets which are initially addressed to the proscribed site are routed to the desired site via one or more autonomous routing systems which are distinct from the network service provider and the desired destination site.

38. A method of preventing an end user of a network from being exposed to an undesired site, comprising:
identifying one or more undesired sites;
providing one or more desired sites;
arranging for the rerouting of an end user's request for connection to an undesired site so that the request is routed to a desired site.

39. A method as claimed in claim 38, wherein the method is a method of protecting an end user of a network from exposure to an undesired web site which is part of a fraud.

40. A method as claimed in claim 38, wherein arranging for the re-routing of the end user's request comprises arranging for a network service provider to re-route a request from an end user.

41. A method as claimed in claim 40, wherein the method includes arranging for the network service provider to route the end user's request for connection to an undesired site, via at least one intermediate routing system, to the desired site.

42. A method as claimed in claim 39, wherein the method includes arranging for a tunnel to be provided between the network service provider and a provider of the desired site.

43. A method as claimed in claim 38, wherein the network service provider is an ISP.

44. A method as claimed in claim 2, wherein the method is a method of re-routing a request by an end user of the internet for connection to a website.

45. A method as claimed in claim 2, wherein the method includes alteration of one or more routing protocols used by the service provider.

46. A method as claimed in claim 45, wherein the method includes alteration of routing preferences used by the service provider in respect of the routing of requests for connection to at least one proscribed site.

47. A method as claimed in claim 44, wherein the method is a method of re-routing a request by an end user made by the end user activating a link.

48. A method as claimed in claim 47, wherein the method is a method of re-routing a request by an end user made by the end user activating a hypertext link.

49. A method as claimed in claim 47, wherein the method comprises re-routing a request by an end user made by the end user activating a link contained in an email.

50. A method as claimed in claim 47, wherein the method comprises re-routing a request by an end user for connection to a website, in the circumstances that the requested website is not the website to which the end user believes connection is being requested.

51. A method as claimed in claim 47, wherein the method comprises re-routing a request made by an end user for connection to a website, where the request is made by the end user activating a link to a proscribed site, said link being disguised as a link to a different, non-proscribed, site.

52. A method as claimed in claim 51, wherein the method comprises receiving payment from an entity related to the non-proscribed website.

53. A method as claimed in claim 52, wherein the entity provides information regarding the identity of one or more proscribed sites.

54. A method as claimed in claim 52, wherein the entity provides information which is provided to the end user via the desired destination site.

55. A method as claimed in claim 2, wherein a re-routing administrator communicates details of the one or more proscribed sites to the network service provider.

56. A method as claimed in claim 55, wherein the re-routing administrator provides information to at least one network service provider relating to why a proscribed site has been determined to be proscribed.

57. A method as claimed in claim 56, wherein said at least one network service provider is given the option of accepting or declining re-routing instructions in relation to a given proscribed site, based on the information relating to why that given proscribed site has been determined to be proscribed.

58. A method as claimed in claim 2, wherein a re-routing administrator provides the desired destination site.

59. A method as claimed in claim 58, wherein at least one entity with an interest in re-routing users' requests to a proscribed site provides information regarding the identity of one or more proscribed sites to the re-routing administrator, and the re-routing administrator includes information provided by the entity on the desired destination site.

60. A method as claimed in claim 2, wherein the proscribed site is a site which imitates a non-proscribed site to which users of the non-proscribed site disclose confidential information.

61. A method as claimed in claim 60, wherein the proscribed site is a site which imitates a site of an entity such as a financial institution.

62. A method as claimed in claim 2, wherein the desired destination site provides an explanation to the end user relating to the user's request for connection to the proscribed site.

63. A method as claimed in claim 2, wherein the end user's request for connection to the proscribed site includes an address for the proscribed site.

64. A method as claimed in claim 63, wherein the connection between the network service provider and the desired destination site allows routing to the desired destination site without advertising the address of the proscribed site to intermediate routers.

65. A method as claimed in claim 64, wherein the connection between the network service provider and the desired destination site allows routing to the desired destination site without making the address of the proscribed site available to intermediate routers.

66. A method as claimed in claim 2, wherein the connection between the network service provider and the desired destination site is a tunnel.

67. A method as claimed in claim 66, wherein the tunnel is created using an IP tunnelling protocol.

68. A method as claimed in claim 2, wherein the method comprises selecting more than one proscribed destination site, and wherein connection to the desired destination site comprises connection to a re-routing administrator system which provides more than one desired destination site.

69. A method as claimed in claim 68, wherein a request for connection to a given proscribed site is rerouted to a desired destination site which provides information related to the specific proscribed site to which the rerouted connection request was originally made.

70. A method as claimed in claim 2, wherein the method comprises communication of details of one or more proscribed destination sites to more than one service provider.

71. A method as claimed in claim 2, wherein the or each service provider is an internet service provider (ISP).
